(19) United States
(12) Patent Application Publication
(10) Pub. No.: US 2010/0008339 A1
(43) Pub. Date: Jan. 14, 2010

(54) DUAL MODE PHONE AND METHOD FOR ACTING AS AN ACCESS POINT

(75) Inventor: HSIN-NAN HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/430,119

(22) Filed: Apr. 27, 2009

(30) Foreign Application Priority Data
Jul. 9, 2008 (CN) 200810302673.7

(51) Int. Cl. H04W 88/08; H04M 1/00

(52) U.S. Cl. 370/338; 455/553.1

(57) ABSTRACT

A dual mode phone includes a wireless wide area network (WWAN) antenna, a WWAN module, a wireless local area network (WLAN) antenna, a WLAN module, and a processing module. The WLAN module includes a client mode sub-module, an access point (AP) mode sub-module, and a switch sub-module. The switch sub-module selectively enables the client mode sub-module or the AP mode sub-module according to a WLAN mode selection instruction. The client mode sub-module triggers the dual mode phone to enter a WLAN client mode when enabled. The AP mode sub-module triggers the dual mode phone to enter a WLAN AP mode to provide network access services to other WLAN clients when enabled.

### BACKGROUND

1. Technical Field

The disclosure relates to dual mode phones, and particularly to a dual mode phone with access point function and a method for acting as an access point.

2. Description of Related Art

Wireless communication networks utilize different access protocols, such as wireless wide area network (WWAN), wireless metropolitan area network (WMAN), wireless local area network (WLAN) and wireless personal network. The WWAN, using such technologies as Global System for Mobile Communications (GSM), code division multiple access 2000 (CDMA 2000), and wideband CDMA (WCDMA), can provide wireless communication in wide areas using base stations with better mobility. In contrast, WLAN provides wireless communication in smaller areas but with a faster connection speed.

Access points (AP) are key elements in WLAN, providing connection to the Internet. WLAN clients can communicate or access the Internet via wireless communication with APs. If APs cannot provide access services or there is no AP, WLAN clients cannot communicate or access the Internet.

### BRIEF DESCRIPTION OF THE DRAWINGS

FIG. 1 is a schematic diagram of an application environment of a dual mode phone as disclosed.

FIG. 2 is a schematic diagram of a dual mode phone as disclosed.

FIG. 3 is a flowchart of a first embodiment of a method for acting as an access point as disclosed.

FIG. 4 is a flowchart of a second embodiment of a method for acting as an access point as disclosed.

### DETAILED DESCRIPTION

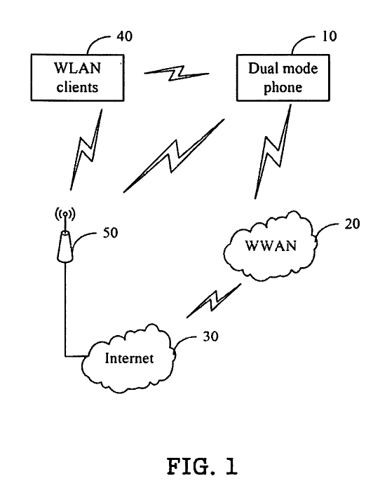

FIG. 1 is a schematic diagram of an application environment of a dual mode phone 10 as disclosed. The dual mode phone 10 is a mobile phone communicating via a wireless local area network (WLAN), that is, as a WLAN client, or communicating via a wireless wide area network (WWAN) 20, such as Global System for Mobile Communications (GSM), code division multiple access 2000 (CDMA 2000), and wideband CDMA (WCDMA). In one embodiment, the dual mode phone 10 has access point (AP) function, such that the dual mode phone 10 can also act as an AP in addition to performing normal operation of a phone.

When in a mobile phone mode, the dual mode phone 10 can communicate with other devices (not shown) and access the Internet 30 via the WWAN 20. When the dual mode phone 10 is in a WLAN mode and further in a WLAN AP mode, WLAN clients 40 (only one shown) can communicate with each other via the dual mode phone 10, and access the Internet 30 via the dual mode phone 10 and the WWAN 20. When in the WLAN mode and further in a WLAN client mode, the dual mode phone 10 can communicate with the WLAN clients 40 or access the Internet 30 via an AP 50.

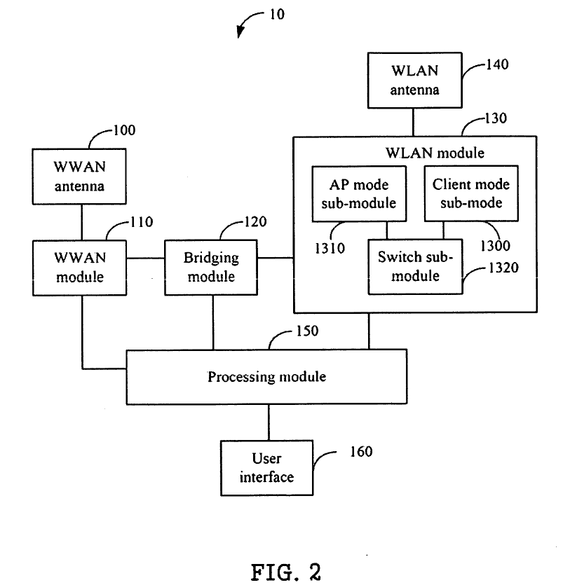

FIG. 2 is a schematic diagram of one embodiment of the dual mode phone 10 as disclosed. In one embodiment, the dual mode phone 10 includes a WWAN antenna 100, a WWAN module 110, a bridging module 120, a WLAN module 130, a WLAN antenna 140, a processing module 150, and a user interface 160.

The WWAN antenna 100 is operable to receive and transmit WWAN radio frequency (RF) signals. The WWAN module 110 is operable to process the WWAN RF signals from the WWAN antenna 100 and generate and output WWAN RF signals to the WWAN antenna 100 to send out. The WLAN antenna 140 is operable to receive and transmit WLAN RF signals. The WLAN module 130 is operable to process the WLAN RF signals from the WLAN antenna 140 and generate and output WLAN RF signals to the WLAN antenna 140 to send out. The processing module 150 is operable to process signals from the WWAN module 110, the WLAN module 130, and the user interface 160 and control flow directions of the signals. The user interface 160 allows operational interface with the dual mode phone 10.

In one embodiment, the WLAN module 130 includes a client mode sub-module 1300, an AP mode sub-module 1310, and a switch sub-module 1320. The client mode sub-module 1300 is operable to trigger the dual mode phone 10 to enter the WLAN client mode when enabled. At this time, the dual mode phone 10 can communicate with the WLAN clients 40 or access the Internet 30 via the AP 50. The AP mode sub-module 1310 is operable to trigger the dual mode phone 10 to enter the WLAN AP mode to provide network access services to the WLAN clients 40 when enabled. At this time, the WLAN clients 40 can communicate with each other or access the Internet 30 via the dual mode phone 10 acting as an AP. The switch sub-module 1320 is connected to the client mode sub-module 1300 and the AP mode sub-module 1310, and is operable to selectively enable the client mode sub-module 1300 or the AP mode sub-module 1310 according to a WLAN mode selection instruction input by a user. In one embodiment, the switch sub-module 1320 may be implemented by software, but it is understand that the switch sub-module 1320 can alternatively be implemented by hardware while remaining well within the scope of the disclosure.

The bridging module 120 is operable to connect the WWAN module 110 and the WLAN module 130, and specifically to convert and exchange data between the WWAN module 110 and the WLAN module 130 when the AP mode sub-module 1310 is enabled and the dual mode phone 10 enters the WLAN AP mode. That is, when the dual module phone 10 acts as an AP, the bridging module 120 converts data from the WWAN module 110 to data usable by the WLAN, and converts data from the WLAN module 130 to data usable by the WWAN.

The user interface 160 is connected to the processing module 150, and is further operable to receive the WLAN mode selection instruction. The switch sub-module 1320 receives the WLAN mode selection instruction from the user interface 160 through the processing module 150 to selectively enable the client mode sub-module 1300 or the AP mode sub-module 1310. In one embodiment, the WLAN mode selection instruction can be generated via menu selection, including a WLAN AP mode selection instruction and a WLAN client mode selection instruction. The user interface 160 is further operable to receive a bridging module enablement instruction and a WWAN module enablement instruction to enable the bridging module 120 and the WWAN module 110 via the processing module 150, respectively. It is understood that the WWAN module 110 may be automatically enabled by the processing module 150 when the AP mode sub-module 1310 and the bridging module 120 are both enabled.

In one embodiment, the WLAN AP mode includes a first WLAN AP mode and a second WLAN AP mode. The dual mode phone 10 enters the first WLAN AP mode to allow the WLAN clients 40 to access the Internet 30 via the dual mode phone 10 when the AP sub-module 1310, the bridging module 120, and the WWAN module 110 are all enabled. The dual mode phone 10 enters the second WLAN AP mode to allow the WLAN clients 40 to communicate with each other via the dual mode phone 10 when only the AP sub-module 1310 is enabled, and at this time, the WLAN clients 40 cannot access the Internet 30 via the dual mode phone 10.

When the dual mode phone 10 enters the first WLAN AP mode, if access to the Internet 30 is wanted, the WLAN clients 40 send a WLAN RF signal to the dual mode phone 10 to establish communication. The WLAN antenna 140 receives and sends the WLAN RF signal to the WLAN module 130. The WLAN module 130 processes the WLAN RF signal, determines a destination of the WLAN RF signal, and sends the processed WLAN RF signal to the bridging module 120 upon the condition that the destination of the WLAN RF signal is the Internet 30. Because the WWAN and the WLAN transmit different RF signals, the bridging module 120 converts the processed WLAN RF signal to a WWAN RF signal, and sends the WWAN RF signal to the WWAN module 110 to process. Then the WWAN antenna 110 sends the processed WWAN RF signals to the Internet 30 via the WWAN to establish communication between the WLAN clients 40 and the Internet 30. When the dual mode phone 10 receives signals from the Internet 30, the transmitting and converting flows are conversely opposite.

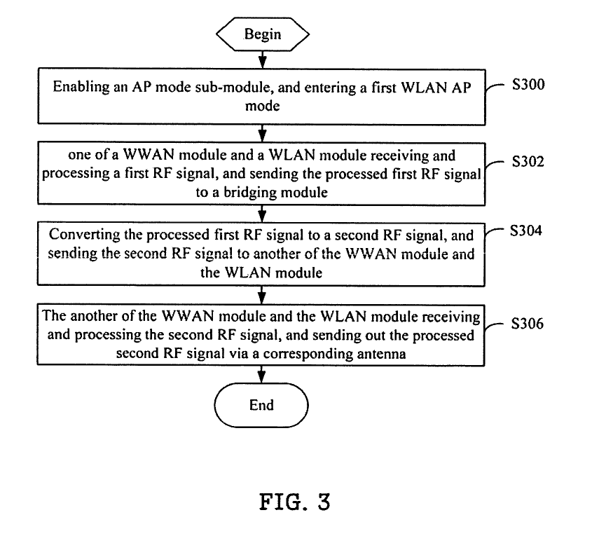

FIG. 3 is a flowchart of one embodiment of a method for acting as an access point of the dual mode phone 10 as disclosed. In block S300, the AP mode sub-module 1310 is enabled, and the dual mode phone 10 enters the first WLAN AP mode. In block S302, one of the WWAN module 110 and the WLAN module 130 receives and processes a first RF signal from a corresponding antenna, and sends the processed first RF signal to the bridging module 120. In one embodiment, the one of the WWAN module 110 and the WLAN module 130 also determines a destination of the first RF signal. In block S304, the bridging module 120 converts the processed first RF signal to a second RF signal, and sends the second RF signal to another of the WWAN module 110 and the WLAN module 130. In block S306, the another of the WWAN module 110 and the WLAN module 130 receives and processes the second RF signal, and sends out the processed second RF signal via a corresponding antenna. Thus, even if the AP 50 cannot provide services, the WLAN clients 40 can still access the Internet 30 via the dual mode phone 10.

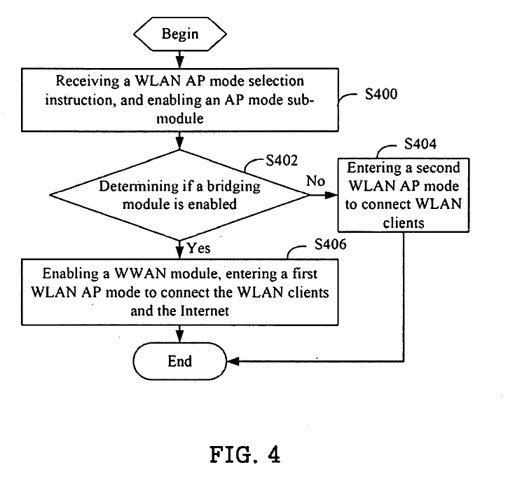

FIG. 4 is a flowchart of a second embodiment of a method for acting as an access point of the dual mode phone 10 as disclosed. In block S400, the user interface 160 receives a WLAN AP mode selection instruction, and the AP mode sub-module 1310 is enabled by the switch sub-module 1320. In one embodiment, the WLAN AP mode can be actively selected by menu. Alternatively, when the dual mode phone 10 is in the WLAN client mode, if the dual mode phone 10 cannot find the AP 50, the WLAN module 130 sends a signal to the user interface 160 via the processing module 150 to prompt selection of the WLAN AP mode.

In block S402, the user interface 160 determines if the bridging module 120 is enabled, based on, In one embodiment, receipt of a bridging module enablement instruction. If the bridging module 120 is disabled, in block S404, the dual mode phone 10 enters the second WLAN AP mode to connect the WLAN clients 40, and the WLAN clients 40 can only communicate with each other via the dual mode phone 10.

If the bridging module 120 is enabled, in block S406, the WWAN module 110 is enabled, and dual mode phone 10 enters the first WLAN AP mode to connect the WLAN clients 40 and the Internet 30, and the WLAN clients 40 can communicate with each other and access the Internet 30 via the dual mode phone 10. In one embodiment, the user interface 160 receives a WWAN module enablement instruction to enable the WWAN module 110 via the processing module 150. It is understood that the WWAN module 110 may be automatically enabled by the processing module 150 when the AP mode sub-module 1310 and the bridging module 120 are both enabled.

The dual mode phone 10 can act as an AP, thus, in the WLAN, even if the AP 50 cannot provide service, the WLAN clients 40 can also communicate with each other or access the Internet 30 via the dual mode phone 10.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A dual mode phone, comprising a wireless wide area network (WWAN) antenna, a WWAN module, a wireless local area network (WLAN) antenna, a WLAN module, and a processing module, wherein the WLAN module comprises:
a client mode sub-module operable to trigger the dual mode phone to enter a WLAN client mode when enabled;
an access point (AP) mode sub-module operable to trigger the dual mode phone to enter a WLAN AP mode to provide network access services to other WLAN clients when enabled; and
a switch sub-module operable to selectively enable the client mode sub-module or the AP mode sub-module according to a WLAN mode selection instruction.

2. The dual mode phone of claim 1, further comprising a bridging module operable to convert and exchange data between the WWAN module and the WLAN module when the AP mode sub-module is enabled.

3. The dual mode phone of claim 2, wherein the WLAN AP mode comprises a first WLAN AP mode and a second WLAN AP mode.

4. The dual mode phone of claim 3, wherein the dual mode phone enters the first WLAN AP mode to allow the other WLAN clients to access the Internet via the dual mode phone when the AP mode sub-module, the bridge module, and the WWAN module are all enabled.

5. The dual mode phone of claim 3, wherein the dual mode phone enters the second WLAN AP mode to allow the other WLAN clients to communicate with each other via the dual mode phone when only the AP mode sub-module is enabled.

6. The dual mode phone of claim 2, further comprising a user interface connected to the processing module, operable to receive the input WLAN mode selection instruction.

7. The dual mode phone of claim 6, wherein the switch sub-module receives the WLAN mode selection instruction from the user interface through the processing module to selectively enable the client mode sub-module or the AP mode sub-module.

8. The dual mode phone of claim 6, wherein the user interface is further operable to receive a bridging module enablement instruction to enable the bridging module via the processing module.

9. The dual mode phone of claim 8, wherein the user interface is further operable to receive a WWAN module enablement instruction to enable the WWAN module via the processing module.

10. The dual mode phone of claim 8, wherein the processing module is operable to automatically enable the WWAN module when the AP mode sub-module and the bridging module are both enabled.

11. A method for acting as an access point, used in a dual mode phone comprising a wireless wide area network (WWAN) antenna, a WWAN module, a wireless local area network (WLAN) antenna, a WLAN module, and a processing module, comprising:
providing an access point (AP) mode sub-module and a client mode sub-module of the WLAN module;
receiving an WLAN AP mode selection instruction, and enabling the AP mode sub-module;
determining if a bridge module is enabled; and
if the bridging module is enabled, enabling the WWAN module, and entering a first WLAN AP mode to connect WLAN clients and the Internet; or
if the bridging module is disabled, entering a second WLAN AP mode to connect the WLAN clients.

12. The method for acting as an access point of claim 11, wherein the block of determining if a bridge module is enabled comprises:
receiving a bridging module enablement instruction; and
enabling the bridging module via the processing module.

13. The method for acting as an access point of claim 12, wherein the block of enabling the WWAN module comprises:
receiving a WWAN module enablement instruction; and
enabling the WWAN module via the processing module.

14. The method for acting as an access point of claim 12, wherein enabling the WWAN module comprises automatically enabling the WWAN module by the processing module when the bridging module is enabled.

15. The method for acting as an access point of claim 11, further comprising:
one of the WWAN module and the WLAN module receiving and processing a first radio frequency (RF) signal, and sending the processed first RF signal to the bridging module;
converting the processed first RF signal to a second RF signal, and sending the second RF signal to another of the WWAN module and the WLAN module; and
processing and sending out the second RF signal.

16. The method for acting as an access point of claim 15, further comprising:
the one of the WWAN module and the WLAN module determining a destination of the first RF signal.

17. A dual mode phone, comprising a wireless wide area network (WWAN) antenna, a WWAN module, a wireless local area network (WLAN) antenna, a WLAN module, and a processing module, wherein the WLAN module comprises:
a client mode sub-module operable to trigger the dual mode phone to enter a WLAN client mode when enabled;
an access point (AP) mode sub-module operable to trigger the dual mode phone to enter a WLAN AP mode when enabled; and
a switch sub-module operable to selectively enable the client mode sub-module or the AP mode sub-module according to a WLAN mode selection instruction;
wherein when the dual mode phone enters the WLAN AP mode, the dual mode phone acts as an AP to allow other WLAN clients to communicate with each other or access the Internet via the dual mode phone.

18. The dual mode phone of claim 17, further comprising a bridging module operable to convert and exchange data between the WWAN module and the WLAN module to allow the other WLAN clients to access the Internet via the dual mode phone.
